(19) United States
(12) Patent Application Publication
(10) Pub. No.: US 2002/0175076 A1
(43) Pub. Date: Nov. 28, 2002

(54) Layered composite with an insulation layer

(76) Inventors: Frieder Gora, Aschaffenburg (DE); Stefan Malkmus, Nurnberg (DE); Christina Modes, Frankfurt am Main (DE); Annette Kipka, Alzenau (DE)

Correspondence Address: Klaus P Stoffel, Cohen Pontani Lieberman & Pavane, 551 Fifth Avenue Suite 1210, New York, NY, 10176, US

(21) Appl. No.: 10/111,358

(22) PCT Filed: Aug. 22, 2001
(86) PCT No.: PCT/EP01/09702

(30) Foreign Application Priority Data
Aug. 24, 2000 (DE) 100-41-554.7

(51) Int. Cl. G01N 27/407; C04B 35/01

(52) U.S. Cl. 204/421; 264/618

(57) ABSTRACT

A laminated assembly having a first layer, a second layer, and at least one sintered insulating film for electrical insulation of the first layer from the second layer. The first layer is one of a first solid electrolyte layer that conducts oxygen ions and a first electrically conducting layer. The second layer is one of a second solid electrolyte layer that conducts oxygen ions and a second electrically conducting layer. The insulating film is formed on a substrate using a paste or a suspension produced from at least one of a ceramic powder and a glass powder. One of the first layer and the second layer serves at least partly as the substrate. The sintered insulting film has a thickness ≦10 μm, and the powder is a nanoscale powder with a BET specific surface >50 m²/g and a maximum particle size of 100 nm.

The invention concerns a laminated assembly with at least one insulating film for the electrical insulation of a first layer from a second layer, in which the first layer is a first solid electrolyte layer that conducts oxygen ions or a first electrically conducting layer, and the second layer is a second solid electrolyte layer that conducts oxygen ions or a second electrically conducting layer, such that the insulating film is formed on a substrate with the use of a paste or a suspension produced from a ceramic powder and/or from a glass powder, such that the first layer serves at least partly as the substrate or the second layer serves as least partly as the substrate, and such that the sintered insulating film has a thickness <10 μm. The invention also concerns a process for producing a laminated assembly of this type, in which the insulating film is formed on the substrate with the use of a paste or a suspension produced from a ceramic powder and/or a glass powder, and in which a first layer formed as a film or a first layer applied to a substrate serves as the substrate for the insulating film.

Laminated assemblies of this type are well known. Many different types of systems have already been proposed in the area of high-temperature and gas sensor analysis, especially in regard to the formation of an electrically insulating film between a solid electrolyte layer that consists, for example, of yttrium-doped or scandium-doped ZrO₂, HfO₃, CeO₂, or ThO₂, and an electrically conducting, current-carrying layer. Noble metals that are resistant to oxidation, such as platinum, are usually used in exhaust gas sensor technology for conducting layers, especially heating layers or heating structures. For the sake of better bonding of a conducting layer with the substrate, the conducting film may contain, in addition to the noble metal, small concentrations of other components, such as organic binders or materials adapted to the substrate, such as ZrO₂ or Al₂O₃. To prevent electrolytic decomposition of the solid electrolyte due to an excessively high current load, mainly ceramic oxide compounds that are stable at high temperatures, such as Al₂O₃, have been used for the electrical insulation between the solid electrolyte and the current-carrying layer.

Of course, several requirements must be placed on the insulating film to ensure that it will function properly over extended periods of time. For example, for use at high temperatures >300° C., the formation of a suitable insulating film requires a sufficiently high electrical resistance of the film material. The sintering and firing behavior of the insulating film is also critically important. For example, during the production of the laminated assembly, neither warping of the assembly nor peeling or cracking of the insulating film may be allowed to occur, since these problems could impair the insulating capacity. In addition, high film thicknesses of the insulating film may necessitate the use of a screen-printed, interlaminar binder layer, a so-called “sealing film”.

EP 0 394 272 B1 describes a possible insulation system with a PCT temperature sensor in ceramic film technology and a process for producing such a sensor. In this connection, the PCT resistor and the conducting tracks are hermetically sealed from the measured gas and from the ambient air. Ceramic films based on Al₂O₃ with thicknesses in the range of 0.1 to 0.6 mm are used for the electrical insulation of individual films. Additives that improve adhesion, such as ZrO₂ or silicates, may be used in the insulating film. The joining of the films may be realized with the aid of a screen-printed, interlaminar binder layer based on Al₂O₃, which has the function of a sealing film. To increase the electrical resistance of the solid electrolyte film in surface regions by averages other than providing an additional insulating film, the idea of incorporating pentavalent metal ions, such as Nb⁵⁺ ions or Ta⁵⁺ ions, in the solid electrolyte host lattice has been advanced.

This process is described in greater detail in DE 3 726 479 C2 and EP 0 683 895 B1. To achieve galvanic separation of circuits, an insulating film is produced between a solid electrolyte material and an electrically conducting layer. In this regard, the insulating film, the thickness of which is selected to be not much greater than 10 μm, can be formed on the basis of Al₂O₃ with pentavalent metal ions also present. These ions diffuse into the solid electrolyte material during sintering and increase its electrical resistance. However, this is attended by the problem that the diffusion process slowly continues during the use of the sensor, so that over time the electrical resistance of the solid electrolyte material increases throughout the material and not just near its surface. This has a negative effect on the properties of the sensor, especially the ability of the solid electrolyte material to conduct oxygen ions. This makes it difficult to control the process.

DE 4 400 370 A1 describes another possibility for electrically insulating protection or for masking films for an electrochemical exhaust gas sensor based on a mixture of crystalline, nonmetallic material, such as Al₂O₃, magnesium spinel, forsterite, partially stabilized or nonstabilized ZrO₂ or HfO₂, and a glass-forming material, such as an alkaline-earth silicate. It is recommended that the film be applied by plasma spraying or that it be applied in the form of an engobe.

DE-OS 195 26 074 A1 describes a powder mixture of this type for producing a sintered, electrically insulating ceramic film for a gas sensor. In this case, in addition to the glass-forming material, the use of a crystalline, nonmetallic powder with a particle-size distribution of d₅₀<0.40 μm and d₉₀<0.50 μm is recommended.

DE 198 34 276 A1 describes an exhaust gas probe with insulating films based on Al₂O₃, in which a pore-forming material is present in the film before sintering is carried out. The film preferably contains at least 80% α-Al₂O₃ with an average particle size of about 0.3 μm and finely divided carbon with an average particle size of 1-10 μm as the pore-forming material.

EP 834 487 A1 describes a process for joining already sintered Al₂O₃ materials for a pressure sensor. A backing material and a ceramic membrane are joined by a joining material made of a nanoscale, highly pure Al₂O₃, which has a maximum particle size of 100 nm. Sintering aids are added in amounts such that, after sintering, they are present in the joining material in a maximum concentration of 5 wt. %. No heed is given here to a high electrical insulating effect of the joining layer.

DE 198 25 094 C1 describes a ceramic, diffusion-limiting film for sensors, in which an at least partially thermally pretreated oxide-ceramic powder with a BET (Brunauer, Emmett, and Teller) specific surface of 5-50 m²/g and an average primary particle size of 20-450 nm is used. Here again, no heed is given to a high electrical insulating effect of the film.

Therefore, the goal of the invention is to develop a different laminated assembly with an insulating film, especially for an exhaust gas sensor, and a process for producing this laminated assembly, such that the insulating film should be as inert and dense as possible and should have a high electrical insulating capacity.

The goal with respect to the laminated assembly is achieved by using a nanoscale powder with a BET specific surface >50 m²/g and a maximum particle size of 100 nm to produce the insulating film. An insulating film in a laminated assembly of this type has a high sinter density due to the high sinter activity of the nanoscale powder. The low porosity of the insulating film and a low concentration of impurities in the powder make it possible to achieve small film thicknesses and at the same time a high electrical insulating capacity. Despite different coefficients of thermal expansion of the materials used for a laminated assembly, little or no warping occurs. Thus, it is also possible to produce a so-called “unsymmetrical” laminated assembly, in which an insulating film is placed unsymmetrically in the laminated assembly (for example, on only one side of a solid electrolyte material). Therefore, the total thickness of the laminated assembly can be made smaller than that of conventional laminated systems. Nevertheless, the mechanical strength of the laminated assembly is not adversely affected. The resistance to thermal shock of the laminated assembly is actually increased. There is no risk of delamination with the laminated assembly of the invention. The use of additional sealing films also becomes unnecessary.

It is especially advantageous if the ratio of the thickness of the insulating film to the thickness of the substrate is at least 1:100 and especially at least 1:200.

The electrical resistivity of the insulating film at 700° C. should be greater than that of ZrO₂ stabilized with 8 mole % Y₂O₃ by a factor of at least 100.

The electrical resistivity of the insulating film at 600° C. should be greater than that of ZrO₂ stabilized with 8 mole % Y₂O₃ by a factor of at least 1,000.

It was found to be especially advantageous for the nanoscale powder to have a BET specific surface of 90-110 m²/g and an average particle size (d₅₀) of 5-20 nm, and especially 10-15 nm.

A thickness of the sintered insulating film of 3-7 μm was found to be advantageous. The insulating film can be formed by a screen-printing or stencil-printing process or by a spray process. The first and/or the second solid electrolyte layer may be formed as a film, which may serve as the substrate for the insulating film. A ceramic powder that consists of Al₂O₃ with a purity >99% is preferred for the insulating film. However, the ceramic powder may also consist of nonstabilized ZrO₂ or of a mixture of Al₂O₃ and fully stabilized, partially stabilized, or nonstabilized ZrO₂. When these materials are used, there is no danger of impairment of the ability of the solid electrolyte material to conduct oxygen ions. SiO₂ is an example of a material that is especially well suited as a glass powder with a high electrical insulating capacity.

An ideal use of a laminated assembly with at least one insulating film made from a nanoscale powder as described above is for a sensor that is used in hot gases. In this regard, the sensor may be a temperature sensor or a gas sensor, which is used, for example, in the exhaust system of a motor vehicle.

The goal with respect to the process is achieved by using the first layer formed as a film or the substrate in the green state, covering at least the first layer with the insulating film, covering the insulating film with the second layer, and sintering this laminated assembly at a temperature of 1,300-1,500° C. This process is recommended when a second layer is to be applied by a thick-film process.

However, the goal with respect to the process is also achieved by providing at least the first layer with the insulating film, sintering the first layer with the insulating film at a temperature of 1,300-1,500° C., and then covering the insulating film with the second layer. This process is recommended when a second layer is to be applied by a thin-film process. In an advantageous embodiment of the process, the insulating film is applied to the first layer by a thick-film or thin-film process. It was found to be especially advantageous for the insulating film to be screen-printed.

The electrically conducting layers may also be produced by a thick-film or thin-film process. Screen printing is especially suitable as a thick-film process, and sputtering or thermal spraying is especially suitable as a thin-film process.

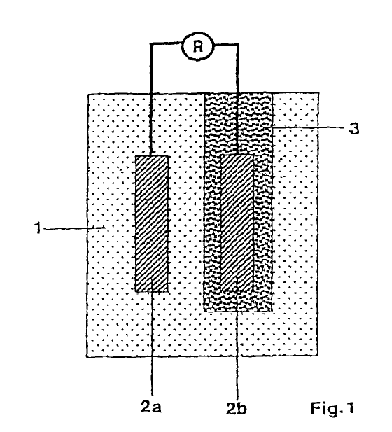

Example 1 and FIG. 1 show an example of a process for producing laminated assemblies in accordance with the invention and the testing of the electrical insulating capacity of an insulating film.

Example 1

A commercial nanoscale powder with an Al₂O₃ content >99% (e.g., Degussa aluminum oxide C), an average particle size d₅₀ of 13 nm, and a BET specific surface of 100±15 m²/g is processed into a screen-printable paste with a solids content of 8-20 wt. %. The paste is printed by screen printing on an oxygen-ion-conducting, green, solid electrolyte film that consists of Y₂O₃-doped ZrO₂ to produce an insulating film. The green film has a thickness of 0.6 mm. The thickness of the printed insulating film is selected in such a way that a thickness of <10 μm is obtained after sintering. In an additional step, a platinum paste is applied by screen printing to the dried insulating film to form a conducting layer or a heating layer, which is then dried. The laminated assembly is sintered in a single step at 1400° C. The test setup shown in FIG. 1 was used to determine the electrical insulating capacity of the insulating film towards the solid electrolyte film.

TABLE 1
ELECTRICAL RESISTIVITY ρ IN kΩ-cm.

| | temperature: | | | |
|---|---|---|---|---|
| laminated assembly: | 600° C. | | 700° C. | |
| Pt - nano-Al₂O₃ (>99%) - | 675 | kΩ-cm | 135 | kΩ-cm |
| 8 mole % Y₂O₃-stabilized ZrO₂ | | | | |
| Pt | | | | |
| stabilized ZrO₂, published | 0.06 | kΩcm | 0.16 | kΩcm |
| value* | | | | |
| (* DE 198 39 382; 9 mole % | | | | |
| Y-stabilized ZrO₂) | | | | |

FIG. 1 shows a sintered laminated assembly with a film 1 of solid electrolyte material that conducts oxygen ions and two conducting layers 2a, 2b of equal size located on it. An insulating film 3 is situated between one of the two conducting layers 2b and the solid electrolyte material 1. To evaluate the insulating capacity of the insulating film 3, we measure the resistance R between conducting layer 2a located directly on the solid electrolyte material 1 and the conducting layer 2b located on the insulating film 3. The geometric dimensions of the test setup can be used to convert the resistance R to electrical resistivity and compare it to published values for the electrical resistance of stabilized ZrO₂.

1. Laminated assembly with at least one insulating film for the electrical insulation of a first layer from a second layer, in which the first layer is a first solid electrolyte layer that conducts oxygen ions or a first electrically conducting layer, and the second layer is a second solid electrolyte layer that conducts oxygen ions or a second electrically conducting layer, such that the insulating film is formed on a substrate with the use of a paste or a suspension produced from a ceramic powder and/or from a glass powder, such that the first layer serves at least partly as the substrate or the second layer serves as least partly as the substrate, and such that the sintered insulating film has a thickness <10 μm, characterized by the fact that the powder is a nanoscale powder with a BET specific surface >50 m²/g and a maximum particle size of 100 nm.

2. Laminated assembly in accordance with claim 1, characterized by the fact that the ratio of the thickness of the insulating film to the thickness of the substrate is at least 1:100.

3. Laminated assembly in accordance with claim 2, characterized by the fact that the ratio of the thickness of the insulating film to the thickness of the substrate is at least 1:200.

4. Laminated assembly in accordance with any of claims 1 to 3, characterized by the fact that the electrical resistivity of the insulating film at 700° C. is greater than that of ZrO₂ stabilized with 8 mole % Y₂O₃ by a factor of at least 100.

5. Laminated assembly in accordance with any of claims 1 to 3, characterized by the fact that the electrical resistivity of the insulating film at 600° C. is greater than that of ZrO₂ stabilized with 8 mole % Y₂O₃ by a factor of at least 1,000.

6. Laminated assembly in accordance with any of claims 1 to 5, characterized by the fact that the nanoscale powder has a BET specific surface of 90-110 m²/g.

7. Laminated assembly in accordance with any of claims 1 to 6, characterized by the fact that the average particle size (d₅₀) of the nanoscale powder is 5-20 nm.

8. Laminated assembly in accordance with claim 7, characterized by the fact that the average particle size (so) of the nanoscale powder is 10-15 nm.

9. Laminated assembly in accordance with any of claims 1 to 8, characterized by the fact that the thickness of the sintered insulating film is 3-7 μm.

10. Laminated assembly in accordance with any of claims 1 to 9, characterized by the fact that the insulating film is formed by a screen-printing or stencil-printing process or by a spray process.

11. Laminated assembly in accordance with any of claims 1 to 10, characterized by the fact that the first and/or the second solid electrolyte layer is formed as a film.

12. Laminated assembly in accordance with claim 11, characterized by the fact that the film is the substrate for the insulating film.

13. Laminated assembly in accordance with any of claims 1 to 12, characterized by the fact that the ceramic powder consists of Al₂O₃ with a purity >99%.

14. Laminated assembly in accordance with any of claims 1 to 12, characterized by the fact that the ceramic powder consists of nonstabilized ZrO₂ or a mixture of Al₂O₃ and fully stabilized, partially stabilized, or nonstabilized ZrO₂.

15. Laminated assembly in accordance with any of claims 1 to 14, characterized by the fact that the glass powder consists of SiO₂.

16. Use of a laminated assembly with at least one insulating film made from a nanoscale powder in accordance with claims 1 to 15 for a sensor that is used in hot gases.

17. Use in accordance with claim 16, characterized by the fact that the sensor is a temperature sensor and/or a gas sensor.

18. Use in accordance with one or both of claims 16 and 17, characterized by the fact that the sensor is used in the exhaust system of a motor vehicle.

19. Process for producing a laminated assembly in accordance with any of claims 1 to 15, in which the insulating film is formed on the substrate with the use of a paste or a suspension produced from a ceramic powder and/or a glass powder, and in which a first layer formed as a film or a first layer applied to a substrate serves as the substrate for the insulating film, characterized by the fact that the first layer formed as a film or the substrate is used in the green state, that at least the first layer is covered with the insulating film, that the insulating film is covered with the second layer, and that this laminated assembly is sintered at a temperature of 1,300-1,500° C.

20. Process for producing a laminated assembly in accordance with any of claims 1 to 15, in which the insulating film is formed on the substrate with the use of a paste or a suspension produced from a ceramic powder and/or a glass powder, and in which a first layer formed as a film or a first layer applied to a substrate serves as the substrate for the insulating film, characterized by the fact that the first layer formed as a film or the substrate is used in the green state, that at least the first layer is covered with the insulating film, that the first layer with the insulating film is sintered at a temperature of 1300-1500° C., and that the insulating film is then covered with the second layer.

21. Process in accordance with one or both of claims 19 and 20, characterized by the fact that the insulating film is applied to the first layer by a thick-film or thin-film process.

22. Process in accordance with claim 21, characterized by the fact that the insulating film is screen-printed.

23. Process in accordance with any of claims 19, 21, or 22, characterized by the fact that electrically conducting layers are applied by a thick-film process.

24. Process in accordance with any of claims 20 to 22, characterized by the fact that electrically conducting layers are applied by a thin-film process.

25. Process in accordance with claim 23, characterized by the fact that electrically conducting layers are produced by screen printing.

26. Process in accordance with claim 24, characterized by the fact that electrically conducting layers are produced by sputtering or thermal spraying.

27. Process in accordance with any of claims 19 to 26, characterized by the fact that the substrate consists of Al₂O₃ and is preferably an Al₂O₃ film.
